(19) United States
(12) Patent Application Publication
(10) Pub. No.: US 2006/0187802 A1
(43) Pub. Date: Aug. 24, 2006

(54) Array of cnt heads

(76) Inventor: William S Oakley, San Jose, CA (US)

Correspondence Address: PERKINS COIE LLP, P.O. BOX 2168, MENLO PARK, CA, 94026, US

(21) Appl. No.: 10/563,456

(22) PCT Filed: Jun. 18, 2004
(86) PCT No.: PCT/US04/19871

§ 371 Date: Jan. 3, 2006

(30) Foreign Application Priority Data
Jul. 3, 2003 (US) 60484632

(51) Int. Cl. G11B 9/00

(52) U.S. Cl. 369/126

(57) ABSTRACT

A method and apparatus for adaptive read and read-after-write for carbon nanotube recorders is described. In one embodiment, the invention is an apparatus. The apparatus includes an array of carbon nanotube heads. The apparatus also includes a substrate upon which the array of carbon nanotube heads are mounted. In an alternate embodiment, the invention is a method. The method includes determining a predetermined track to operate on. The method also includes deflecting a beam of a carbon nanotube head of the array of carbon nanotube heads toward the predetermined track.

### FIELD

The present invention relates to the field of data storage systems. More particularly, the present invention relates to data storage systems utilizing carbon nanotubes in conjunction with disk media.

### BACKGROUND

Disk drive technology based on magnetic and laser technology continues to allow for denser information packing. However, each technology has its limits and defects, related to both physical limitations and mechanical limitations. Lasers and magnetic heads must be positioned by mechanical means and have minimum tolerances for the physical size of marks used to encode data on their respective media. Moreover, use of single heads limits bandwidth for data transfer to and from disk media.

### SUMMARY

A method and apparatus for adaptive read and read-after-write for carbon nanotube recorders is described. In one embodiment, the invention is an apparatus. The apparatus includes an array of carbon nanotube heads. The apparatus also includes a substrate upon which the array of carbon nanotube heads are mounted. In an alternate embodiment, the invention is a method. The method includes determining a predetermined track to operate on. The method also includes deflecting a beam of a carbon nanotube head of the array of carbon nanotube heads toward the predetermined track.

### BRIEF DESCRIPTION OF THE DRAWINGS

The accompanying drawings, which are incorporated in and form a part of this specification, illustrate embodiments of the invention and, together with the description, serve to explain the principles of the invention. The drawings should be understood as illustrative of the invention, rather than restrictive.

FIG. 1 is an embodiment of a head using a CNT (carbon nanotube).

FIG. 2 is an illustration of an embodiment of an array of CNT heads as used in a disk drive.

FIG. 3 is an embodiment of a carbon nanotube (CNT) head as used for reading.

FIG. 4 is an illustration of an embodiment of a disk drive using multiple arrays of CNT heads.

### DETAILED DESCRIPTION

A method and apparatus utilizing an array of CNT (carbon nanotube) heads is described. In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

A method and apparatus for adaptive read and read-after-write for carbon nanotube recorders is described. In one embodiment, the invention is an apparatus. The apparatus includes an array of carbon nanotube heads. The apparatus also includes a substrate upon which the array of carbon nanotube heads are mounted. In an alternate embodiment, the invention is a method. The method includes determining a predetermined track to operate on. The method also includes deflecting a beam of a carbon nanotube head of the array of carbon nanotube heads toward the predetermined track.

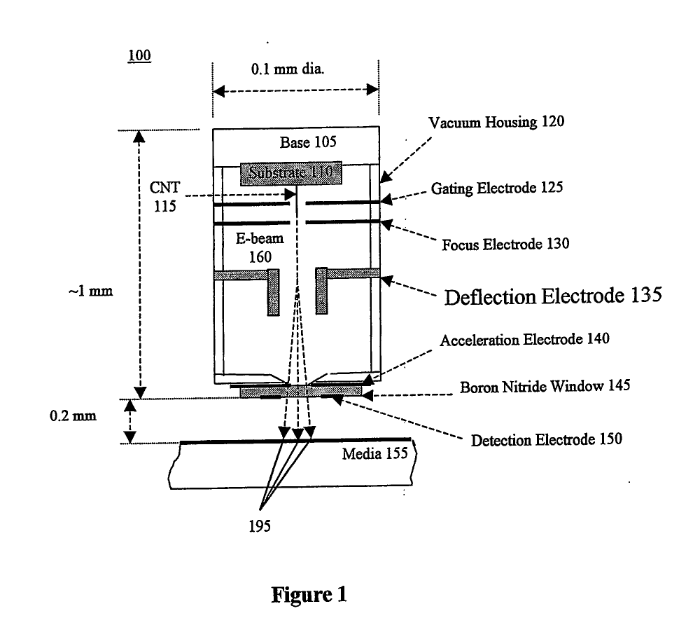

Disk drives are limited in performance in several areas that seem inherent in their nature. These include the complexity of the read/write head, the need for a mechanical ‘swing-arm’ actuator to access the data tracks, and the need for a ‘low flying head’. A new technology is described that overcomes these limitations and enables a new approach to disk drives where the only moving part in a drive is the disk itself. The design approach is based on electron beam recording using a Carbon NanoTube (CNT) as a micro-cathode emitter. A typical CNT Read-Write head assembly is shown in FIG. 1.

Electrons are extracted from the CNT in a beam and focused onto the recording media forming nanometer sized marks, e.g. in the range of 1 to 25 nanometers in diameter. The head contains electrostatic deflection electrodes that enable the beam to be scanned or positioned radially as desired for tracking. The R/W head is fabricated using micro-lithography and several similar heads can be configured in proximity as a group to provide servo tracking, write, and read functions simultaneously. Arrays of hundreds of heads can be fabricated on the same chip. The beam in each head can be deflected about 100 microns off axis in either direction so each head can access a data swath forming an annular zone 0.2 mm wide on the disk without the head having to move. For example, a disk 20 mm in diameter has an active zone between radii of 10 mm and perhaps 3.6 mm, i.e. an annular region 6.4 mm wide. As each head can access a 0.2 mm wide zone, only 32 CNT heads (or head groups) are required to access the entire disk. The heads are static and only the data disk rotates.

FIG. 1 illustrates a specific embodiment of a carbon nanotube head which may be used as described above. Head 100 includes a base 105 having mounted thereon a substrate 110 from which a CNT 115 extends. Also mounted on base 105 is vacuum housing 120 which allows for an evacuated or sealed environment in which CNT 115 may operate. Within housing 120, gating electrode 125 (used to turn the e-beam 160 from CNT 115 on or off) and focus electrode 130 (used to focus the e-beam 160 from CNT 115) are located. Also, deflection electrode 135 is located within vacuum housing 120, allowing for deflection of e-beam 160 to each of locations 195 on media 155.

One end of housing 120 includes an opening around which acceleration electrode 140 is arranged. The opening of housing 120 is covered by a boron nitride window 145 which is relatively transparent to e-beam 160 but is relatively impervious to atmospheric transfer into vacuum housing. Arranged outside window 145 are detection electrodes 150 which may be used to detect scattered electrons bouncing back from media 155. As illustrated, base 105 and vacuum housing 120 have a width (diameter) of about 0.1 mm, with the overall structure having a length of about 1 mm and a spacing from media 155 of about 0.2 mm. These dimensions may be chosen based on specific design details, and are thus not requirements so much as a set of specifications useful in one embodiment. Moreover, the boron nitride window 145 is exemplary of a suitable window material, rather than a restrictive indication of the only suitable window material.

The data is read by monitoring Secondary Emission (SE) electrons emitted by the media when probed by an e-beam of lower intensity than the write beam. The write mark is imprinted onto the phase change media by the higher power write beam that changes the media phase and thereby the degree of SE from the media.

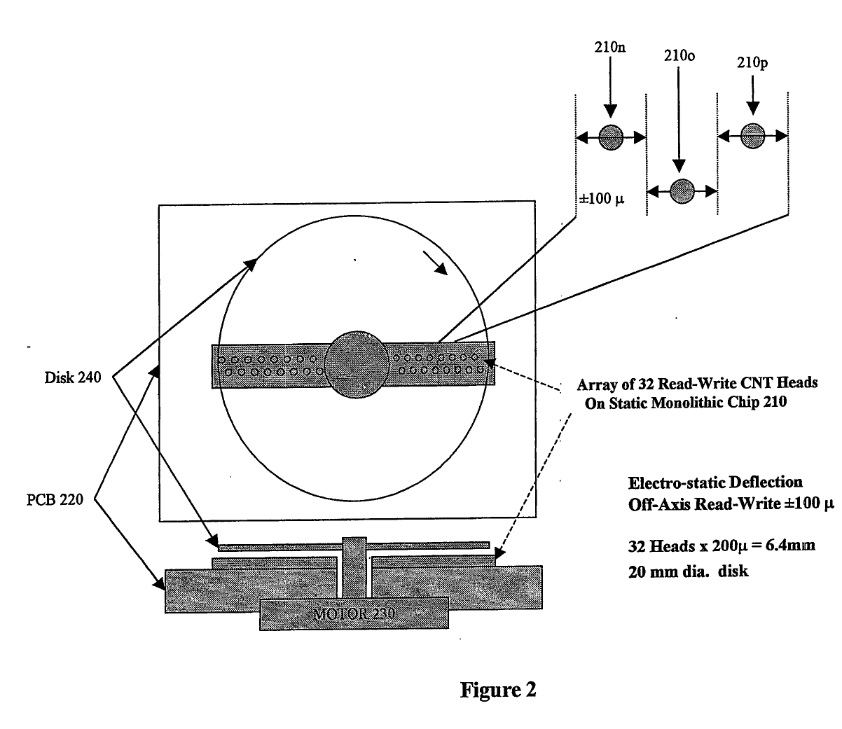

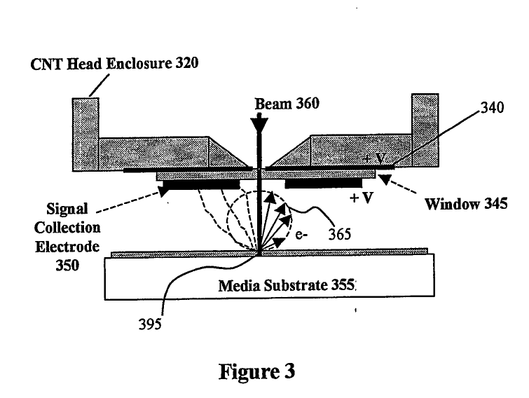

One embodiment is illustrated in the drive configuration as in FIG. 2. As shown a PCB mounted motor rotates the disk, and several CNT head arrays are located on the same PCB in proximity to the disk. The heads are staggered so that SE electrons from one head will not interfere with a neighboring head. The detection pattern from a head is shown in FIG. 3. Also shown are typical electron paths (left of center), and the relative SE intensity (right of center).

Turning to FIG. 2, the details of an embodiment of a disk drive using an array of CNTs as read/write heads is illustrated. Array 210 is an array of 32 CNT heads, arranged as illustrated with respect to heads 210n, 210o and 210p to provide access to all tracks on a disk 240. Disk 240 spins about a spindle turned by motor 230. Motor 230 is coupled, along with array 240 to a substrate or PCB (printed circuit board) 220. As illustrated, only the disk 240 spins, the array 210 and PCB 220 are stationary. Within the range of tracks each head of array 210 is to access, the e-beam or electron stream of the individual head is deflected to the desired track, thus allowing for potentially parallel accesses (either read or write) to the disk through each head of the array 210.

FIG. 3 illustrates an embodiment of a head and how it may be used to read from a disk or other medium. CNT head enclosure 320 houses the CNT (not shown) which emits beam 360. Beam 360 is deflected or otherwise steered at an appropriate angle out of the opening through electrodes 340 (acceleration electrodes). Beam 360 passes through window 345 and impinges upon media 355 at location 395. From location 395, electrons 365 scatter, some of which are collected by signal collection electrode 350, resulting in a signal representing the data encoded or embodied by media 355. Note that media 355 may include a substrate and an active layer, wherein the active layer is primarily or solely responsible for storing data, and the substrate provides desired mechanical properties to the media 355.

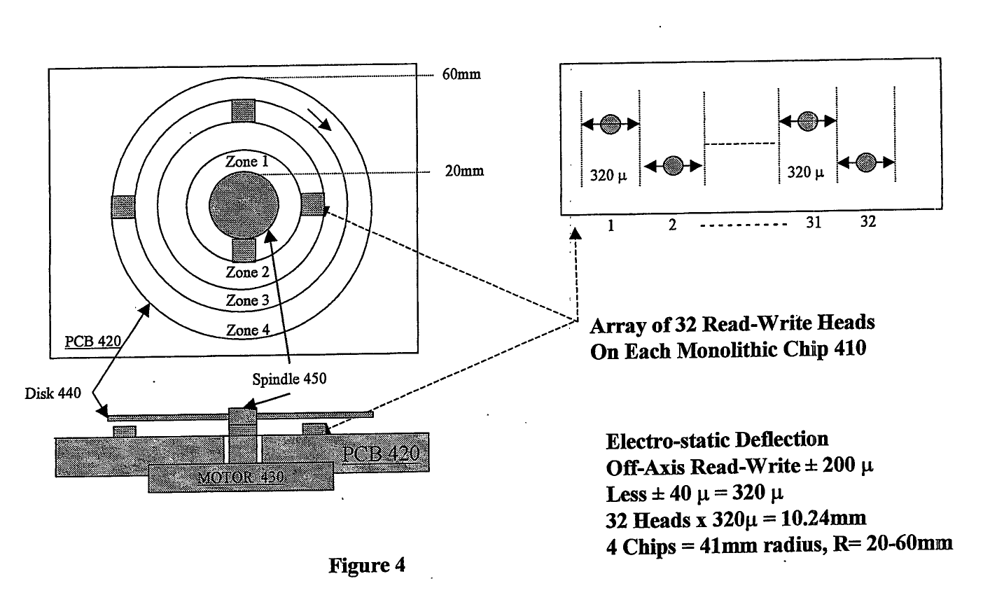

Larger diameter disks can be accommodated by organizing the CNT chip arrays to cover specific annular zones as in FIG. 4. In one embodiment, disk 440 has four zones, each sized such that 32 regularly spaced heads in an array may cover the tracks of a single zone. Thus, zone 1, zone 2, zone 3 and zone 4 each are sized to cover approximately 10 mm of the radius of disk 440. PCB 420 is a printed circuit board in the disk drive in which disk 440 is used. PCB 420 has mounted thereon four arrays 410, each having therein 32 CNT heads useful for read and write operations. The PCB 420 is also coupled to a motor 430 which rotates a spindle 450. Spindle 450 is used to rotate disk 440, thereby allowing for access to the entire surface of disk 440 by arrays 410. Various arrangements of the arrays 410 may be used, although the arrangement illustrated is believed to provide for relatively minimal crosstalk between arrays.

In one embodiment, the invention is an apparatus. The apparatus is a disk drive including a rotating recording disk and an array of CNT heads located on one or more monolithic chips statically mounted in proximity to the disk recording surface, enabling e-beam data tracking, writing and recovery as the disk rotates. Moreover, in some embodiments, the CNT disk drive has the CNT heads positioned in arrays and staggered so as to avoid cross-talk between neighboring heads. Furthermore, in one embodiment, the CNT disk drive has multiple heads which may function independently in a write, read, or track mode. Additionally, in one embodiment, both sides of the disk are utilized to write and read data and the disk is sandwiched between read-write CNT array chips. Furthermore, in one embodiment, a stack of disks are sandwiched between read-write CNT array chips. Also, the CNT array based disk drive may have multiple tracks individually and simultaneously accessed by individual CNT heads enabling a greater data transfer rate. Additionally, the CNT array based disk drive may use a disk that is preformatted and may also contain pre-written data, such as a limited ROM area, as well as areas for writing or a fully ROM disk for example.

From the foregoing, it will be appreciated that specific embodiments of the invention have been described herein for purposes of illustration, but that various modifications may be made without deviating from the spirit and scope of the invention. In some instances, reference has been made to characteristics likely to be present in various or some embodiments, but these characteristics are also not necessarily limiting on the spirit and scope of the invention. In the illustrations and description, structures have been provided which may be formed or assembled in other ways within the spirit and scope of the invention. Similarly, methods have been illustrated and described as linear processes, but such methods may have operations reordered or implemented in parallel within the spirit and scope of the invention. Accordingly, the invention is not limited except as by the appended claims.

1. An apparatus, comprising:
an array of carbon nanotube heads; and
a substrate upon which the array of carbon nanotube heads are mounted.

2. The apparatus of claim 1, wherein:
the array of carbon nanotube heads includes a set of read/write heads.

3. The apparatus of claim 1, wherein:
the array of carbon nanotube heads includes independent controls for each carbon nanotube head.

4. A method of operating an array of carbon nanotube heads with a disk having tracks, comprising:
determining a predetermined track to operate on; and
deflecting a beam of a carbon nanotube head of the array of carbon nanotube heads toward the predetermined track.

5. The method of claim 4, further comprising:
reading data from the predetermined track responsive to the beam impinging on the track.

6. The method of claim 4, further comprising:
writing data to the predetermined track with the beam.

7. The method of claim 6, further comprising:
reading data from a second track with a second carbon nanotube head of the array of carbon nanotube heads.

8. The method of claim 5, further comprising:
writing data to a second track with a second carbon nanotube head of the array of carbon nanotube heads.

9. That which is described and equivalents thereof.
